(19) United States
(12) Patent Application Publication
(10) Pub. No.: US 2011/0260433 A1
(43) Pub. Date: Oct. 27, 2011

(54) SIDE COLLISION DETECTION SYSTEM AND OCCUPANT RESTRAINT SYSTEM

(75) Inventors: Yasuo Itoga, Tokyo (JP); Kazuya Ooi, Tokyo (JP); Atsushi Mihara, Tokyo (JP); Atsuhiko Oigawa, Tokyo (JP); Hiro Kawaguchi, Tokyo (JP)

(73) Assignee: TAKATA CORPORATION

(21) Appl. No.: 13/091,101

(22) Filed: Apr. 20, 2011

(30) Foreign Application Priority Data
Apr. 21, 2010 (JP) 2010-098104

(51) Int. Cl. B60R 21/16

(52) U.S. Cl. 280/730.2; 280/735

(57) ABSTRACT

In order to precisely detect a side collision of a vehicle with a simple configuration, an air bag device has an acceleration sensor which is for detecting a side collision and which is attached to the beam of the vehicle. Hence, in comparison with a case in which a displacement sensor for detecting a side collision is used, the air bag device can have a simplified configuration. Moreover, unlike the displacement sensor, the acceleration sensor needs no adjustment of a positional relationship with a measurement target. Accordingly, the initial adjustment of the air bag device can be carried out within a short time, resulting in a reduction of a production cost of the air bag device.

### CROSS-REFERENCE TO RELATED APPLICATION

This application claims the benefit of Japanese Patent Application No. 2010-98104, filed on Apr. 21, 2010, the entire disclosure of which is incorporated by reference herein.

### FIELD

This application relates generally to a side collision detection system and an occupant restraint system, and more particularly, to a side collision detection system that detects a side collision of a vehicle and an occupant restraint system for restraining an occupant.

### BACKGROUND

Occupant restraint systems built in a vehicle accomplish size reduction and cost reduction, so that most vehicles are normally equipped with such system recently. Moreover, vehicles are also equipped with occupant restraint systems which detect a collision from a side of a vehicle (i.e., a side collision) and which restrain an occupant recently.

In the case of side collision, however, a door is the only structure which absorbs collision energy and which is located closest to an occupant. Hence, in order to protect the occupant from a side collision, it is important to detect a collision within a short time and to expand an air bag rapidly. Unexamined Japanese Patent Application KOKAI Publication No. 2009-101805 discloses a technology of detecting a side collision instantaneously.

A side collision detection system disclosed in Unexamined Japanese Patent Application KOKAI Publication No. 2009-101805 monitors a displacement of a particular position (a specific position) of a beam provided at a door through a displacement sensor. Such a system detects a displacement which is a difference between the specific position before collision and the specific position after collision, thereby detecting a side collision based on the detected displacement and the change level (displacement velocity) of such a displacement.

### SUMMARY

As is represented by the above-explained side collision detection system, a system which detects a side collision using a displacement sensor additionally needs a sensor that outputs a signal for a safing determination. Accordingly, such a side collision detection system typically includes an acceleration sensor that is arranged at a portion other than, for example, a side of the vehicle.

The present invention has been made in view of the foregoing circumstance, and it is an object of the present invention to simplify a system configuration while maintaining the detection precision of a side collision.

In order to achieve the above object, a side collision detection system according to a first aspect of the present invention detects a side collision of a vehicle, and the side collision detection system comprises: a first acceleration sensor which is attached to a beam of a door at a side of the vehicle and which detects an acceleration in a direction orthogonal to a travelling direction of the vehicle; a second acceleration sensor which is provided at a side of the vehicle and which is different from the first acceleration sensor; and a detection device which uses, as a safing signal for determining whether there is a collision, a first signal output by either one of the first and second acceleration sensors, uses, as a detection signal for determining a severity of the collision, a second signal output by another acceleration sensor, and detects a side collision happened to the vehicle.

The first acceleration sensor may be supported on the beam via a support member.

The support member may comprise: a fixing part fixed to the beam; and a support part which has elasticity and supports the first acceleration sensor at a location apart from the fixing part and which attenuates a force transmitted from the beam to the first acceleration sensor by the elasticity.

The support part may support the first acceleration sensor at a location offset downwardly from the fixing part.

The second acceleration sensor may be attached to a pillar of the vehicle.

The vehicle may have two doors at a side, the first acceleration sensor may be attached to the beam of either one of the two doors, and the second acceleration sensor may be attached to the beam of another door.

An occupant restraint system according to a second aspect of the present invention comprises: the above-explained side collision detection system; an occupant restraint device that restrains an occupant of the vehicle; and a control device that controls the occupant restraint device when the side collision detection system detects a side collision.

The occupant restraint device may comprises: an air bag for restraining an occupant of the vehicle; and an expanding device that charges gas in an interior of the air bag to expand the air bag, and the control device activates the expanding device in response to an output by the first or second acceleration sensor.

According to the present invention, a side collision to a side of a vehicle can be detected by an acceleration sensor only that is provided at the side of the vehicle. Hence, it becomes possible to simplify a system configuration while maintaining the detection precision of a side collision.

### BRIEF DESCRIPTION OF THE DRAWINGS

A more complete understanding of this application can be obtained when the following detailed description is considered in conjunction with the following drawings, in which:

FIG. 1 is a block diagram of an air bag device according to a first embodiment;

FIG. 2 is a diagram showing an arrangement of sensors, etc., configuring an air bag device in a vehicle;

FIG. 3 is a diagram showing a condition of an air bag unit after activated;

FIG. 4 is a diagram showing an acceleration sensor together with a beam;

FIG. 5 is a perspective view showing a support member together with the beam;

FIG. 6 is a side view showing the support member together with the beam;

FIG. 7 is a diagram showing a logic circuit exemplifying a process executed by a control device;

FIG. 8 is a diagram for explaining an example side collision;

FIG. 9 is a layout diagram showing sensors, etc., configuring an air bag device of a related art;

FIG. 10 shows a logic circuit exemplifying a process executed by a control device of an air bag device of a related art;

FIG. 11 is a layout diagram of sensors, etc., configuring an air bag device according to a second embodiment;

FIG. 12 is a diagram showing a logic circuit exemplifying a process executed by a control device;

FIG. 13 is a layout diagram of sensors, etc., configuring an air bag device of an example related art;

FIG. 14 shows a logic circuit exemplifying a process executed by a control device of an air bag device of a related art; and

FIG. 15 is a diagram showing a relationship between a moving distance of a beam and a moving speed thereof.

### DETAILED DESCRIPTION

### First Embodiment

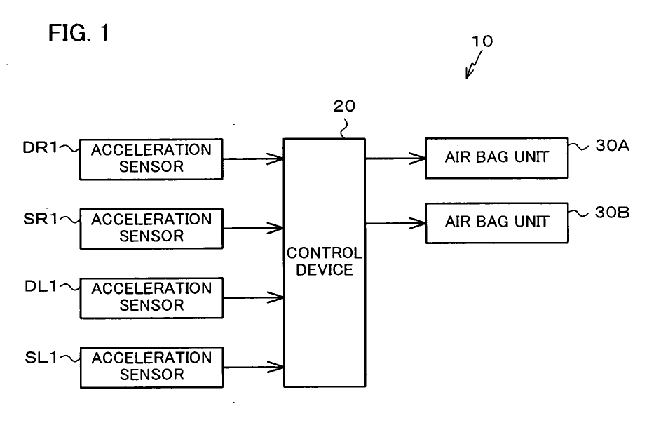

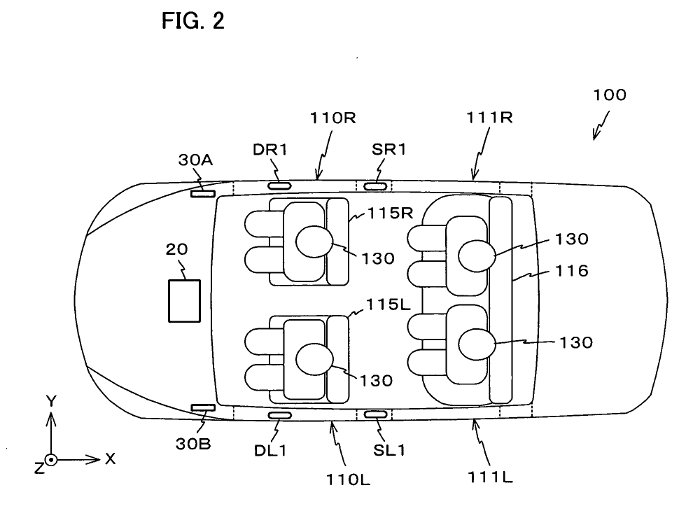

A first embodiment of the present invention will be explained with reference to the accompanying drawings. FIG. 1 is a block diagram of an air bag device 10 according to the first embodiment. FIG. 2 is a diagram showing an arrangement of sensors, etc., configuring the air bag device 10 in a vehicle 100.

The air bag device 10 is for restraining occupants 130 (see FIG. 2) sitting down front seats 115R and 115L and rear seat 116 when a side collision happens to the vehicle 100.

As shown in FIG. 1, the air bag device 10 includes two air bag units 30A and 30B, four acceleration sensors DR1, SR1, DL1 and SL1, and a control device 20 that controls the air bag units 30A and 30B based on signals output by the acceleration sensors.

As shown in FIG. 2, the air bag unit 30A is provided near a right A-pillar configuring the vehicle 100.

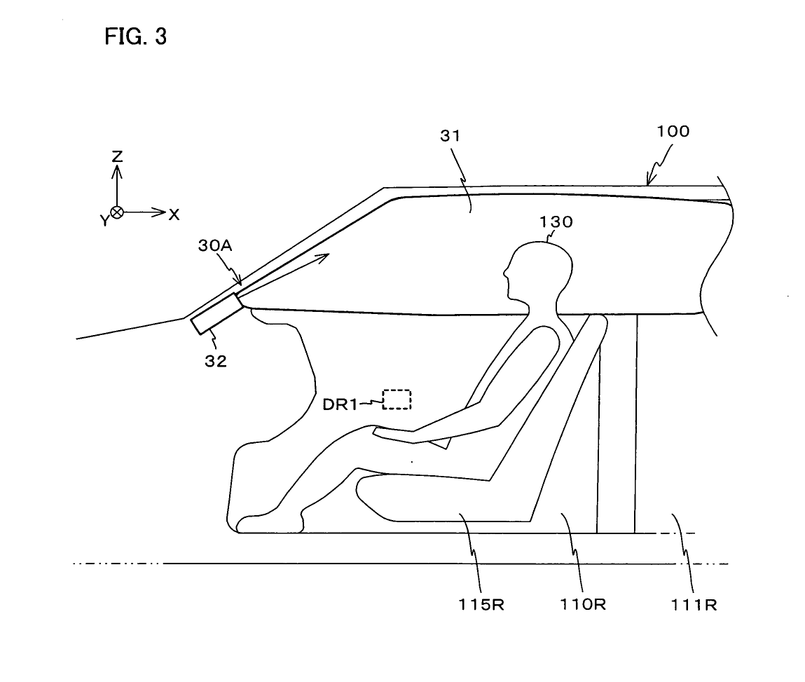

FIG. 3 is a diagram showing the condition of the air bag unit 30A after activated. As shown in FIG. 3, the air bag unit 30A includes an air bag 31 and an inflator 32. As can be seen in FIGS. 2 and 3, when a gas is filled in the interior of the air bag 31, the air bag 31 expands between the head of the occupant 130 and right doors 110R and 111R.

The air bag unit 30B has the same configuration as that of the air bag unit 30A. The air bag unit 30B is arranged near a left A-pillar configuring the vehicle 100.

The acceleration sensors DR1, SR1, DL1 and SL1 detect an acceleration at least in a direction (Y-axis direction) orthogonal to the travelling direction of the vehicle 100. The acceleration sensors DR1, SR1, DL1 and SL1 each outputs a signal with a level corresponding to the detected acceleration.

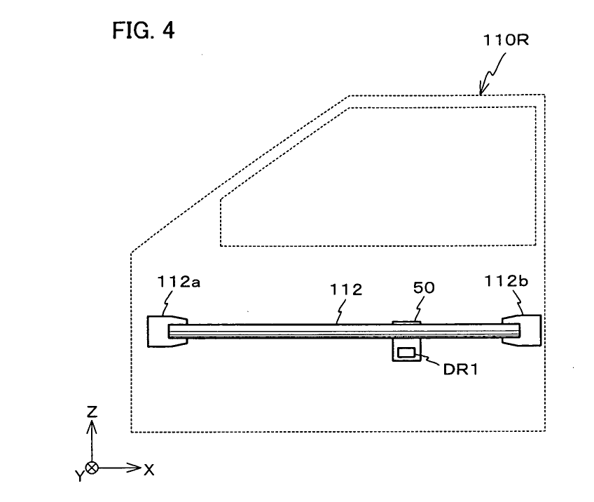

As can be seen in FIG. 2, the acceleration sensor DR1 is arranged between an outer shell configuring the right door 110R of the vehicle 100 and an inner panel of the right door 110R. FIG. 4 shows the acceleration sensor DR1 together with a beam 112. As shown in FIG. 4, the acceleration sensor DR1 is attached to the beam 112 by means of a support member 50.

The beam 112 is a cylindrical member having a lengthwise direction arranged in the X-axis direction. The beam 112 has attachment portions 112a and 112b which are formed at respective ends of the beam 112 and which are attached to the frame of the right door 110R, so that the beam 112 is hanged substantially horizontally.

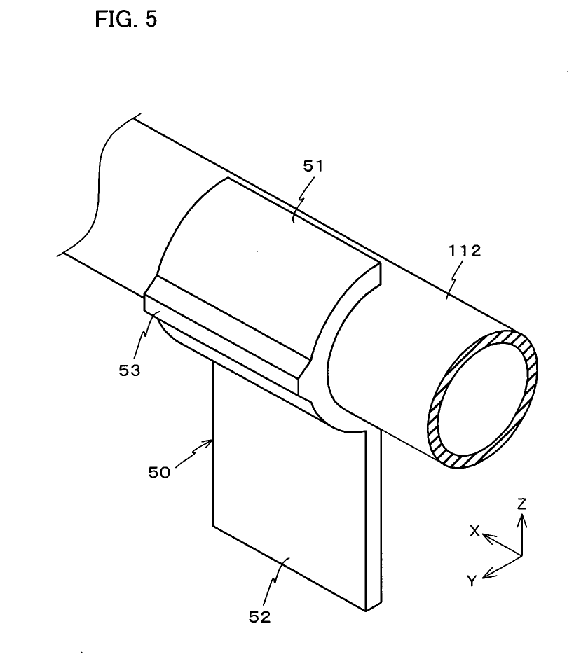

FIG. 5 is a perspective view showing the support member 50 together with the beam 112. As shown in FIG. 5, the support member 50 includes two pieces: a fixing part 51 fixed to the beam 112; and a support part 52 running to the lower direction (−Z-axis direction) from the lower portion of the fixing part 51.

The fixing part 51 has a surface at −Y side which contacts the beam 112 and which is formed in a curved face so as to curve at the same curvature as that of the side face of the beam 112. The surface of the fixing part 51 at +Y side is provided with a protrusion 53 that protrudes in the +Y-axis direction.

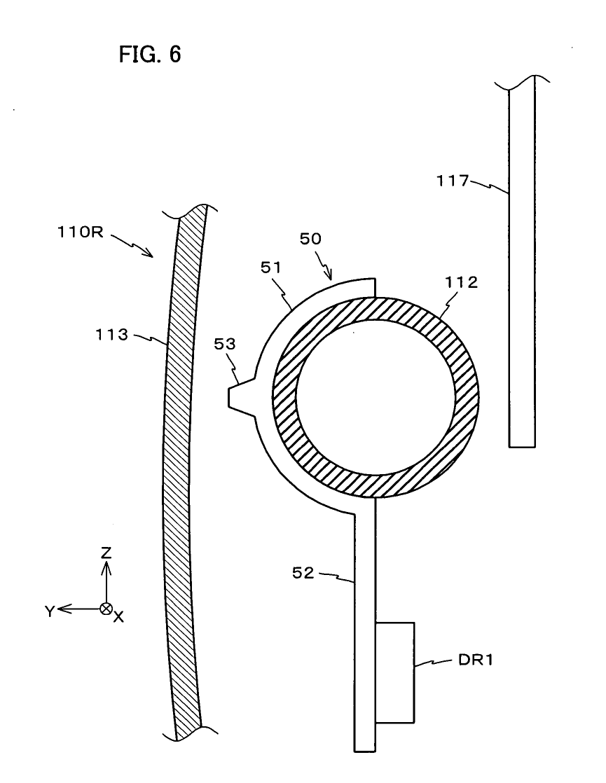

The support part 52 is formed in a long rectangular shape having the lengthwise direction arranged in the Z-axis direction. FIG. 6 is a side view showing the support member 50 together with the beam 112. As shown in FIG. 6, the acceleration sensor DR1 is attached to the face of the support part 52 at −Y side.

The support member 50 is fixed to the beam 112 by welding several portions of the fixing part 51 to the beam 112 with the face of the fixing part 51 at −Y side being contacting the side face of the beam 112. Accordingly, as shown in FIG. 6, the support member 50 has the protrusion 53 facing an outer shell 113 of the right door 110R. The acceleration sensor DR1 is supported below a window 117.

The acceleration sensor DL1 shown in FIG. 2 is attached to a beam 112 provided at the left door 110L configuring the vehicle 100 through a support member 50 like the acceleration sensor DR1.

The acceleration sensor SR1 is attached to a right B-pillar configuring the vehicle 100. Moreover, the acceleration sensor SL1 is attached to a left B-pillar configuring the vehicle 100.

The control device 20 detects a side collision happened to the vehicle 100 through the acceleration sensors DR1, SR1, DL1 and SL1. When detecting a side collision, the control device 20 activates the air bag units 30A and 30B.

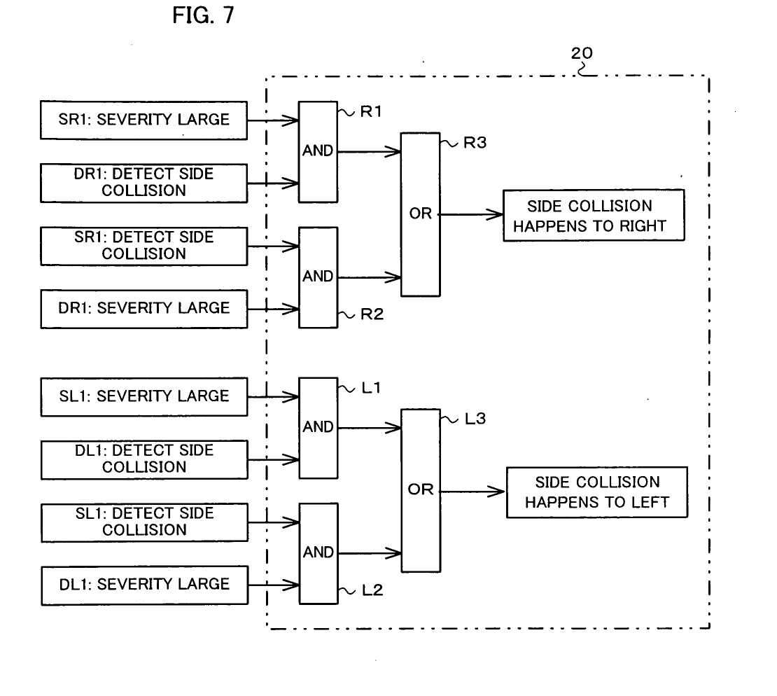

FIG. 7 shows a logic circuit exemplifying a process executed by the control device 20 when a side collision happens to the right of the vehicle 100. An explanation will now be given of an operation of the control device 20 with reference to FIG. 7. In the following explanation, a signal that becomes equal to or larger than a threshold V (on level) at first among signals output by the acceleration sensors DR1, SR1, DL1 and SL1 is referred to as a detection signal. A signal that becomes equal to or larger than the threshold V (on level) at next is referred to as a safing signal.

When a side collision happens to the right of the vehicle 100, the control device 20 determines that the severity of the side collision is equal to or larger than a certain level based on a detection signal from, for example, the acceleration sensor SR1, and executes a process of detecting the side collision based on a safing signal from the acceleration sensor DR1.

In this case, the output signal by an operator R1 becomes an on level, and the output signal by an operator R3 becomes an on level as a result. When the output signal by the operator R3 becomes an on level, the control device 20 determines that a side collision happens to the right of the vehicle 100, and activates the air bag unit 30A.

Moreover, when a side collision happens to the right of the vehicle 100, the control device 20 determines that the severity of the side collision is equal to or larger than a certain level based on a detection signal from the acceleration sensor DR1, and executes a process of detecting a side collision based on a safing signal from the acceleration sensor SR1.

In this case, the output signal by an operator R2 becomes an on level, and the output signal by the operator R3 becomes an on level as a result. When the output signal by the operator R3 becomes an on level, the control device 20 determines that a side collision happens to the right of the vehicle 100, and activates the air bag unit 30A.

When a side collision happens to the left of the vehicle 100, the control device 20 determines that the severity of the side collision is equal to or larger than a certain level based on a detection signal from, for example, the acceleration sensor SL1, and executes a process of detecting the side collision based on a safing signal from the acceleration sensor DL1.

In this case, the output signal by an operator L1 becomes an on level, and the output signal by an operator L3 becomes an on level as a result. When the output signal by the operator L3 becomes an on level, the control device 20 determines that a side collision happens to the left of the vehicle 100, and activates the air bag unit 30B.

Moreover, when a side collision happens to the left of the vehicle 100, the control device 20 determines that the severity of the side collision is equal to or larger than a certain level based on a detection signal from the acceleration sensor DL1, and executes a process of detecting a side collision based on a safing signal from the acceleration sensor SL1.

In this case, the output signal by an operator L2 becomes an on level, and the output signal by the operator L3 becomes an on level as a result. When the output signal by the operator L3 becomes an on level, the control device 20 determines that a side collision happens to the left of the vehicle 100, and activates the air bag unit 30B.

Next, an explanation will be given of an operation of the air bag device 10 having the above-explained configuration. When the occupant 130 turns on the ignition switch of the vehicle 100, the air bag device 10 is activated. Upon activation of the air bag device 10, the control device 20 starts detecting an acceleration of the vehicle 100 through the acceleration sensors DR1, SR1, DL1 and SL1.

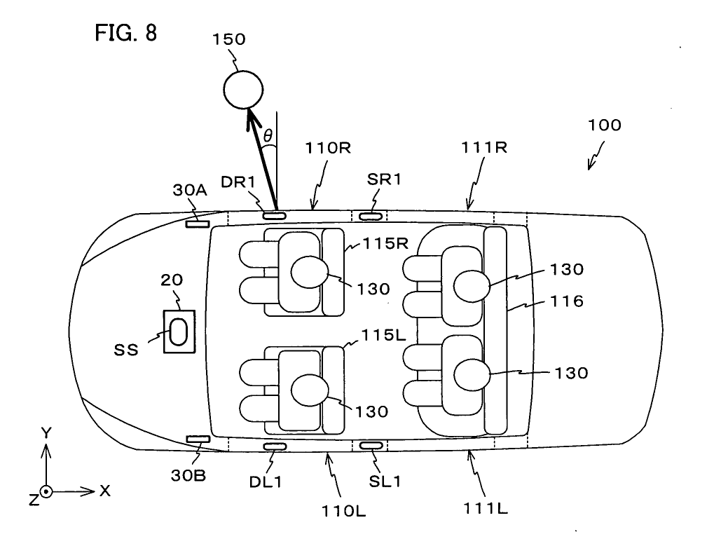

FIG. 8 is a diagram for explaining an example side collision. As shown in FIG. 8, it is presumed that a pole 150 and the right door 110R of the vehicle 100 collide when the vehicle 100 travels in a direction having an angle θ (e.g., 15 degrees) to the Y-axis orthogonal to the travelling direction at a predetermined speed (e.g., 30 km/h).

As can be seen in FIG. 6, in this case, the pole 150 first collides the outer shell 113 of the right door 110R. Next, the pole 150 comes close to the beam 112 together with the outer shell 113 at a speed substantially equal to the speed at the time of collision, and collides the beam 112 or the support member 50 with the outer shell 113 intervening therebetween. According to this collision, the force acting on the beam 112 or the support member 50 is transmitted to the acceleration sensor DR1 through the support part 52 of the support member 50. This causes the output signal by the acceleration sensor DR1 to increase its level, which becomes equal to or larger than the threshold V in time.

The force by collision is also transmitted to the acceleration sensors other than the acceleration sensor DR1 eventually. Accordingly, the output signals by individual acceleration sensors increase the signal level, which becomes equal to or larger than the threshold V in time.

In general, the closer the distance between a collided portion and the acceleration sensor is, the larger the level of the output signal by each acceleration sensor becomes. In this embodiment, an explanation will be given of an example case in which the output signal by the acceleration sensor DR1 becomes equal to or larger than the threshold V at first, and the output signal by the acceleration sensor SR1 becomes equal to or larger than the threshold V at next.

According to the above presumption, the output signal by the acceleration sensor DR1 is a detection signal. The output signal by the acceleration sensor SR1 is a safing signal. In this case, the control device 20 determines that the severity is equal to or larger than a certain level based on the detection signal by the acceleration sensor DR1, and detects a side collision based on the safing signal by the acceleration sensor SR1. Accordingly, as can be seen in FIG. 7, the output signal by the operator R2 becomes an on level, and the output signal by the operator R3 becomes an on level as a result.

When the output signal by the operator R3 becomes an on level, the control device 20 determines that a side collision happens to the right of the vehicle 100, and activates the air bag unit 30A. Hence, as shown in FIG. 3, the air bag 31 expands between the head of the occupant 130 and the right doors 110R and 111R.

Next, an explanation will be given of another example case in which the output signal by the acceleration sensor SR1 becomes equal to or larger than the threshold V at first, and the output signal by the acceleration sensor DR1 becomes equal to or larger than the threshold V at next.

According to the above presumption, the output signal by the acceleration sensor SR1 is a detection signal. The output signal by the acceleration sensor DR1 is a safing signal. In this case, the control device 20 determines that the severity is equal to or larger than a certain level based on the detection signal by the acceleration sensor SR1, and detects a side collision based on the safing signal by the acceleration sensor DR1. Accordingly, the output signal by the operator R1 becomes an on level, and the output signal by the operator R3 becomes an on level as a result.

When the output signal by the operator R3 becomes an on level, the control device 20 determines that a side collision happens to the right of the vehicle 100, and activates the air bag unit 30A. Hence, as shown in FIG. 3, the air bag 31 expands between the head of the occupant 130 and the right doors 110R and 111R.

As explained above, the control device 20 activates the air bag units 30A and 30B based on respective outputs by the acceleration sensors SR1, DR1, SL1 and DL1.

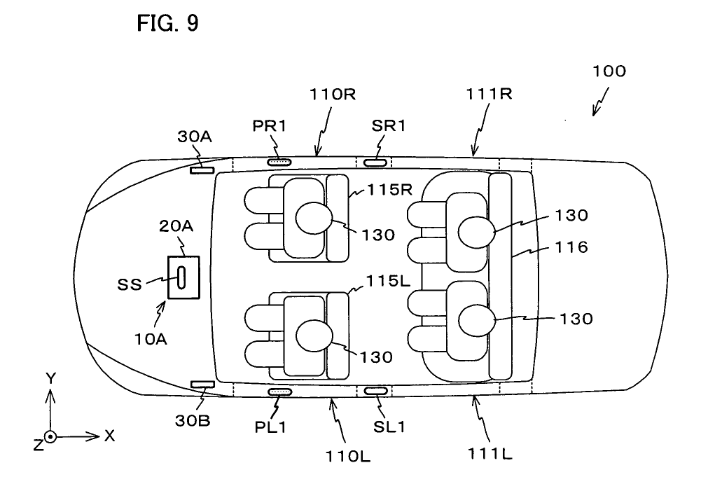

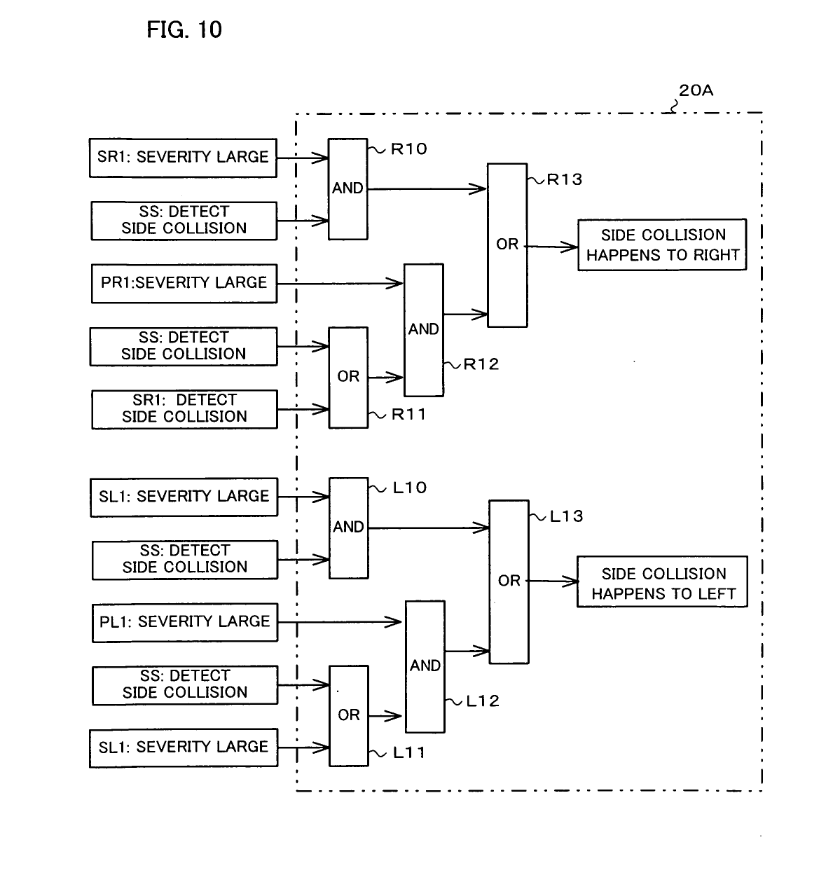

As explained above, the air bag device 10 of the first embodiment includes the acceleration sensors DR1 and DL1 which are attached to the beam 112 of the vehicle 100 and which are for detecting a side collision. Accordingly, in comparison with a case in which a displacement sensor is used as means for detecting a side collision, the air bag device 10 has a simplified configuration. The effect of the first embodiment will be explained below with reference to FIGS. 9 and 10 showing an example related art.

FIG. 9 is a layout diagram of sensors, etc., configuring an air bag device 10A of an example related art. As shown in FIG. 9, the air bag device 10A of the related art has differences from the air bag device 10 of the first embodiment such that an acceleration sensor SS is integrated with a control device 20A and displacement sensors PR1 and PL1, etc., are used instead of the acceleration sensors DR1 and DL1.

The displacement sensors PR1 and PL1 are each for measuring a displacement of a beam of each door 110R and 110L, and each output a signal with a level corresponding to a displacement. Those displacement sensors PR1 and PL1 are mainly for detecting a side collision to the doors 100R and 110L.

FIG. 10 shows a logic circuit exemplifying a process executed by the control device 20A of the air bag device 10A of the related art. When detecting a severity of a side collision based on a detection signal by an acceleration sensor SR1 or an acceleration sensor SL1, the air bag device 10A needs an output signal (a safing signal) by an acceleration sensor other than the acceleration sensors SR1 and SL1. Accordingly, the air bag device 10A additionally needs an acceleration sensor SS that outputs a safing signal.

According to the air bag device 10 of the first embodiment, as can be seen in FIG. 7, when a severity of a side collision happened to the right of the vehicle is detected using a detection signal by the acceleration sensor SR1, the control device 20 can use the output by the acceleration sensor DR1 as a safing signal. Moreover, when a severity of a side collision happened to the right of the vehicle is detected using a detection signal by the acceleration sensor DR1, the control device 20 can use the output by the acceleration sensor SR1 as a safing signal.

When a severity of a side collision happened to the left of the vehicle is detected using a detection signal by the acceleration sensor SL1, the control device 20 can use the output by the acceleration sensor DL1 as a safing signal. Furthermore, when a severity of a side collision happened to the left of the vehicle is detected using a detection signal by the acceleration sensor DL1, the control device 20 can use the output by the acceleration sensor SL1 as a safing signal. Accordingly, the air bag device 10 of the first embodiment needs no additional acceleration sensor corresponding to the acceleration sensor SS in order to obtain a safing signal, and can reduce the number of sensors.

When the displacement sensor is used like the case of the related art, it is necessary to directly attach the displacement sensor to a portion apart from the measurement target. Hence, it is necessary to ensure a space having a size to some extent as an attachment portion of the displacement sensor.

In contrast, according to the first embodiment, the acceleration sensor is directly attached to the measurement target which is represented by the beam 112. Accordingly, it is not necessary to ensure a particular space having a size to some extent as an attachment portion of the acceleration sensor. Accordingly, the degree of freedom for designing increases.

Moreover, the acceleration sensor of the first embodiment needs no adjustment of a portion relative to the measurement target unlike the displacement sensor of the related art. Accordingly, the initial adjustment of the air bag device 10 can be carried out within a short time, resulting in a reduction of a production cost.

Furthermore, the acceleration sensor of the first embodiment can be directly attached to the measurement target. Accordingly, it is possible to directly detect a side collision.

According to the first embodiment, the control device 20 detects a side collision based on dual signals: a detection signal by any one of the acceleration sensors; and a safing signal by the acceleration sensor other than that acceleration sensor outputting the detection signal. The air bag unit to be activated is set based on the dual signals. This avoids a false detection and enables precise detection of a side collision.

According to the first embodiment, the acceleration sensors DR1 and DL1 for detecting a side collision happened to the vehicle 100 are supported below the beam 112 by the support part 52 of the support member 50. Accordingly, even if a force originating from a collision acts on the beam 112, this force is transmitted to the acceleration sensors DR1 and DL1 after being subjected to damping (attenuation) by the support part 52 of the support member 50.

Accordingly, even if the beam 112 moves at an acceleration exceeding the rated input of the acceleration sensors DR1 and DL1, the acceleration to the acceleration sensors DR1 and DL2 is reduced to be equal to or smaller than the rated input. Accordingly, no acceleration equal to or larger than the rated input is input into the acceleration sensors DR1 and DL2, and it becomes possible to prevent a signal by a detection element from being saturated. This enables the air bag device 10 of the first embodiment to precisely detect an occurrence of a side collision.

According to the first embodiment, the explanation was given of a case in which the acceleration sensors SR1 and SL1 are attached to only the B-pillar of the vehicle 100. The present invention is, however, not limited to this case, and an acceleration sensor may be arranged at the C-pillar of the vehicle 100 as an option.

### Second Embodiment

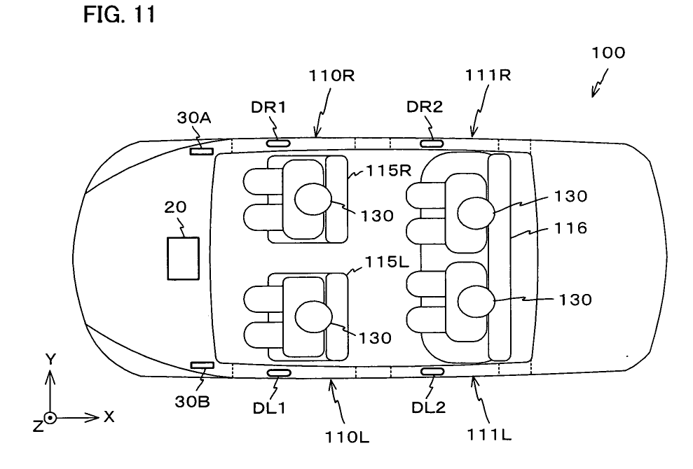

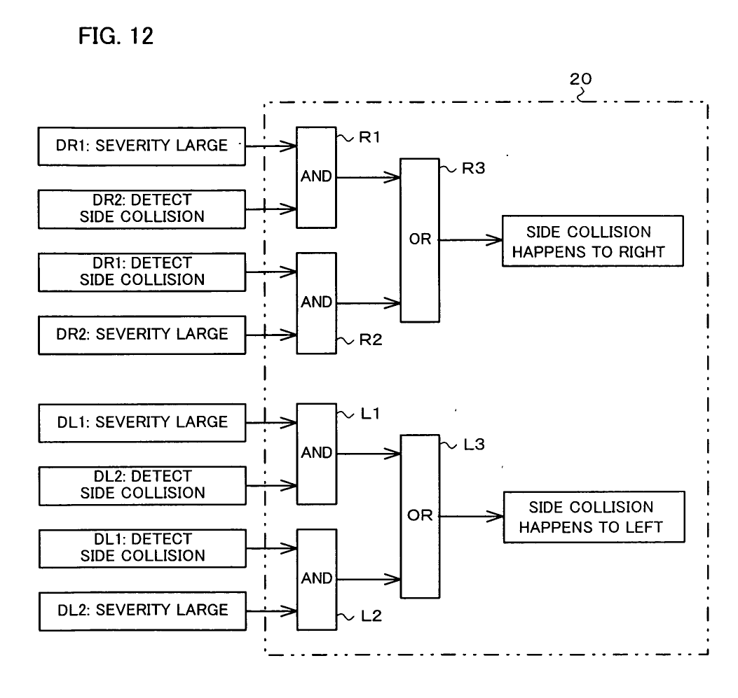

Next, a second embodiment of the present invention will be explained with reference to FIGS. 11 and 12. The same structural elements as those of the first embodiment will be denoted by the same reference numerals, and the duplicated explanation thereof will be omitted.

FIG. 11 is a layout diagram of sensors, etc., configuring an air bag device. As shown in FIG. 11, an air bag device 10 of the second embodiment has a difference from the air bag device 10 of the first embodiment that acceleration sensors DR2 and DL2 are used instead of the acceleration sensors SR1 and SL1.

The acceleration sensors DR2 and DL2 are attached to respective beams 112 provided at the rear doors 111R and 111L of the vehicle 100 through respective support members 50 like the acceleration sensors DR1 and DL1.

FIG. 12 shows a logic circuit exemplifying a process executed by the control device 20 when a side collision happens to the vehicle 100. An explanation will now be given of an operation of the control device 20 with reference to FIG. 12. In the following explanation, a signal that becomes equal to or larger than the threshold V (on level) at first among signals output by the acceleration sensors DR1, DR2, DL1 and DL2 is referred to as a detection signal. A signal that becomes equal to or larger than the threshold V (on level) at next is referred to as a safing signal.

When a side collision happens to the right of the vehicle 100, the control device 20 determines that the severity of the side collision is equal to or larger than a certain level based on a detection signal from, for example, the acceleration sensor DR1, and executes a process of detecting the side collision based on a safing signal from the acceleration sensor DR2.

In this case, the output signal by the operator R1 becomes an on level, and the output signal by the operator R3 becomes an on level as a result. When the output signal by the operator R3 becomes an on level, the control device 20 determines that a side collision happens to the right of the vehicle 100, and activates the air bag unit 30A.

Moreover, when a side collision happens to the right of the vehicle 100, the control device 20 determines that the severity of the side collision is equal to or larger than a certain level based on a detection signal from the acceleration sensor DR2, and executes a process of detecting a side collision based on a safing signal from the acceleration sensor DR1.

In this case, the output signal by the operator R2 becomes an on level, and the output signal by the operator R3 becomes an on level as a result. When the output signal by the operator R3 becomes an on level, the control device 20 determines that a side collision happens to the right of the vehicle 100, and activates the air bag unit 30A.

When a side collision happens to the left of the vehicle 100, the control device 20 determines that the severity of the side collision is equal to or larger than a certain level based on a detection signal from, for example, the acceleration sensor DL1, and executes a process of detecting the side collision based on a safing signal from the acceleration sensor DL2.

In this case, the output signal by the operator L1 becomes an on level, and the output signal by the operator L3 becomes an on level as a result. When the output signal by the operator L3 becomes an on level, the control device 20 determines that a side collision happens to the left of the vehicle 100, and activates the air bag unit 30B.

Moreover, when a side collision happens to the left of the vehicle 100, the control device 20 determines that the severity of the side collision is equal to or larger than a certain level based on a detection signal from the acceleration sensor DL2, and executes a process of detecting a side collision based on a safing signal from the acceleration sensor DL1.

In this case, the output signal by the operator L2 becomes an on level, and the output signal by the operator L3 becomes an on level as a result. When the output signal by the operator L3 becomes an on level, the control device 20 determines that a side collision happens to the left of the vehicle 100, and activates the air bag unit 30B.

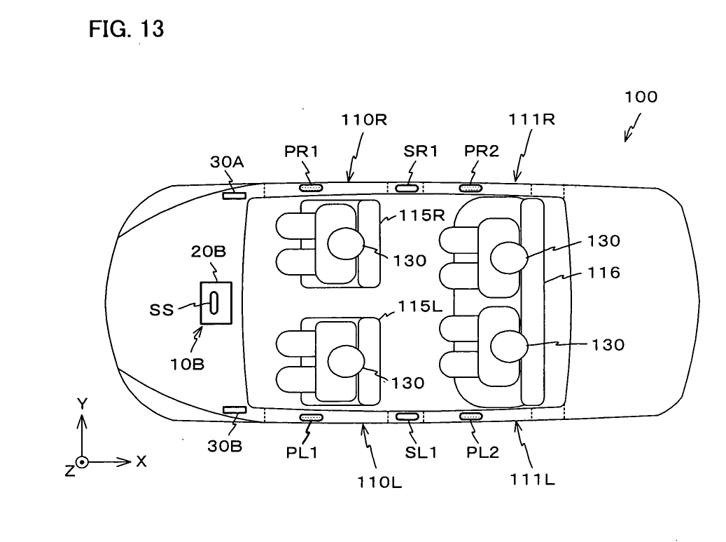

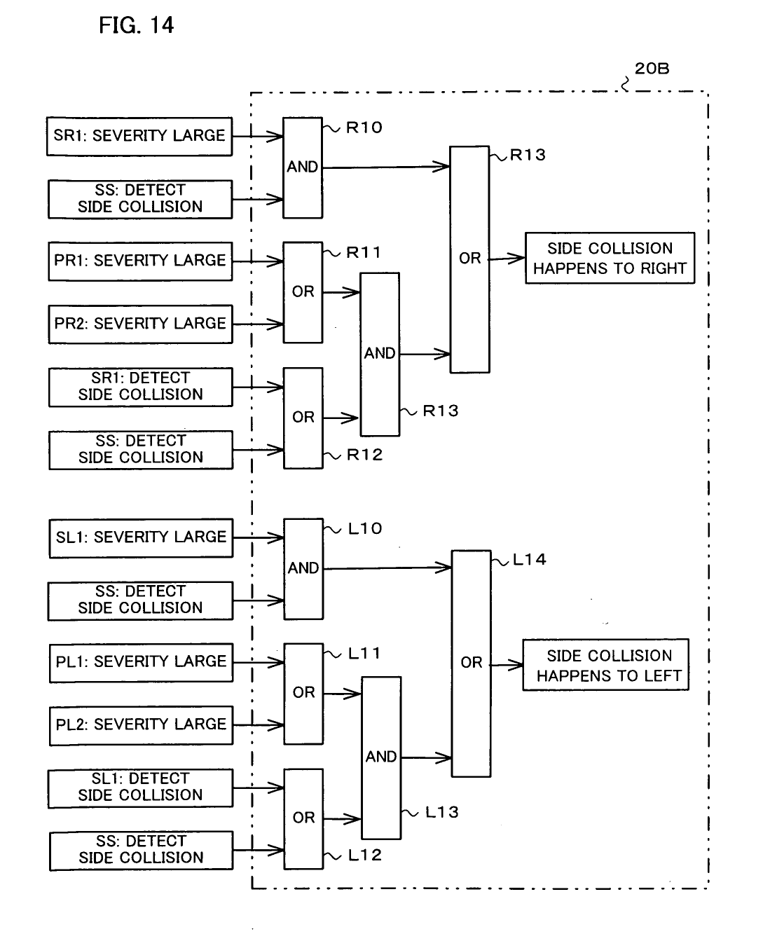

As explained above, the air bag device 10 of the second embodiment has the acceleration sensors DR1, DR2, DL1 and DL2 which are provided at respective doors 110R, 111R, 110L and 111L of the vehicle 100 and which are for detecting a side collision. Accordingly, in comparison with a case in which a displacement sensor is used as means for detecting a side collision, the air bag device 10 can have a simplified configuration. The effect of the second embodiment will be explained with reference to FIGS. 13 and 14 which show an example related art.

FIG. 13 is a layout diagram of sensors, etc., configuring an air bag device 10B of an example related art. As shown in FIG. 13, the air bag device 10B of the related art has differences from the air bag device 10 of the second embodiment such that an acceleration sensor SS is integrated with a control device 20B and displacement sensors PR1, PR2, PL1 and PL2 are used instead of the acceleration sensors DR1, DR2, DL1 and DL2.

The displacement sensors PR1, PR2, PL1 and PL2 of the related art are each for measuring a displacement of a beam, and each output a signal with a level corresponding to a displacement. Output signals by those displacement sensors PR1, PR2, PL1 and PL2 are mainly for detecting a side collision to the doors 100R, 111R, 110L and 111L.

FIG. 14 shows a logic circuit exemplifying a process executed by the control device 20B of the air bag device 10B of the related art. When detecting a severity of a side collision based on a detection signal by an acceleration sensor SR1 or an acceleration sensor SL1, the air bag device 10B needs an output signal (a safing signal) by an acceleration sensor other than the acceleration sensors SR1 and SL1. Accordingly, the air bag device 10B additionally needs an acceleration sensor SS that outputs a safing signal.

According to the air bag device 10 of the second embodiment, as can be seen in FIG. 12, when a severity of a side collision happened to the right of the vehicle is detected using a detection signal by the acceleration sensor DR1, the air bag device 10 can use the output by the acceleration sensor DR2 as a safing signal. Moreover, when a severity of a side collision happened to the right of the vehicle is detected using a detection signal by the acceleration sensor DR2, the air bag device 10 can use the output by the acceleration sensor DR1 as a safing signal.

When a severity of a side collision happened to the left of the vehicle is detected using a detection signal by the acceleration sensor DL1, the control device 20 of the second embodiment can use the output by the acceleration sensor DL2 as a safing signal. Furthermore, when a severity of a side collision happened to the right of the vehicle is detected using a detection signal by the acceleration sensor DL2, the control device 20 of the second embodiment can use the output by the acceleration sensor DL1 as a safing signal. Accordingly, the air bag device 10 of the second embodiment needs no additional acceleration sensor corresponding to the acceleration sensor SS in order to obtain a safing signal, and can reduce the number of sensors.

The embodiments of the present invention were explained above, but the present invention is not limited to the foregoing embodiments.

In the foregoing embodiment, a signal that becomes equal to or larger than the threshold V (on level) at first among signals output by the acceleration sensors DR1, SR1 DL1 and SL1 is taken as a detection signal by the control device 20. Moreover, a signal that becomes equal to or larger than the threshold V (on level) at next is taken by the control device 20 as a safing signal. The detection signal is for determining a severity of a collision and the safing signal is for determining whether there is a collision. Respective definitions of the detection signal and the safing signal are merely examples, and such signals may be defined using different thresholds.

According to the foregoing embodiments, the control device 20 detects a side collision based on the level of a detection signal output by the acceleration sensor and the level of a safing signal output by another acceleration sensor. The present invention is not limited to such a configuration, and the control device 20 may perform, for example, an integral operation on a signal output by the acceleration sensor in order to calculate a moving speed of the beam 112 and the moving distance thereof, and may detect an occurrence of a side collision based on the calculated moving speed and the moving distance.

In this case, information on a threshold V₀ (e.g., 5.56 m/s (=20 km/h)) for a moving speed and on a threshold D₀ (e.g., 15 mm) for a moving distance are given to the control device 20 beforehand. The control device 20 performs an integral operation on a signal output by the acceleration sensor for each reference time, and calculates the moving speed of the beam 112 due to a collision and the moving distance thereof based on the integral operation result. Next, when the calculated moving speed and moving distance both exceed the thresholds, the control device 20 determines that a side collision happens to the vehicle 100.

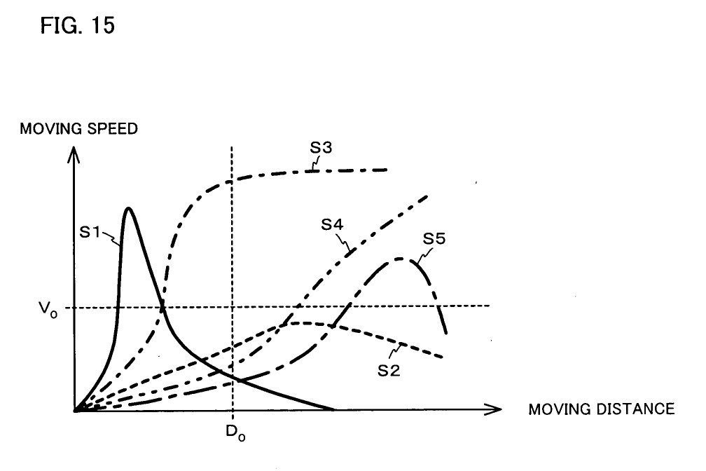

FIG. 15 is a diagram showing a relationship between a moving distance of the beam 112 and a moving speed thereof. Only when the moving speed of the beam 112 exceeds the threshold V₀ after the moving distance of the beam 112 exceeds the threshold D₀, the control device 20 determines that a severe side collision happens to the vehicle 100. Note that a severe side collision means a side collision which may give a bodily injury to the occupant 130.

For example, a curve S1 represents a case in which an object with a small mass collides the side of the vehicle 100 at a fast speed. Regarding the object with a small mass, even if it collides the vehicle 100 at a fast speed, the occupant 130 does not get a large impact. In this case, the control device 20 determines that no severe side collision happens to the vehicle 100.

A curve S2 represents a case in which an object with a large mass collides the side of the vehicle 100 at a slow speed. Even if the object has a large mass, when it collides the vehicle 100 at a slow speed, the occupant 130 does not get a large impact. In this case, the control device 20 determines that no severe side collision happens to the vehicle 100.

Conversely, a curve S3 represents a case in which an object with a large mass collides the vehicle 100 at a fast speed. Moreover, a curve S4 represents a case in which an object with a large mass collides the vehicle 100 at a speed to some extent. Furthermore, a curve S5 represents a case in which an object with a mass to some extent collides the vehicle 100 at a speed to some extent. When the moving distance of the beam 112 and the moving speed thereof shift as indicated by respective curves S3 to S5, the moving speed becomes equal to or larger than the threshold V₀ after the moving distance of the beam 112 becomes equal to or larger than the threshold D₀. In this case, the control device 20 determines that a severe side collision happens to the vehicle 100. Upon determination of the occurrence of the severe side collision, the control device 20 activates the air bag unit 30A or 30B.

According to the foregoing configuration, only when a severe side collision happens to the vehicle 100, the air bag 31 expands. Accordingly, the occurrence frequency of a false operation of the air bag device 10 can be reduced.

The control device 20 of the foregoing embodiments may be configured by hardware resources, or may be configured by an algorithm of a software executed by a computer or a microcomputer that includes a CPU (Central Processing Unit), a main memory unit, and an auxiliary memory unit, etc.

The present invention can be changed and modified in various forms without departing from the broad scope and the spirit of the present invention. The foregoing embodiments are for explaining the present invention, and are not for limiting the scope and the spirit of the present invention.

The side collision detection system of the present invention is suitable for detecting a side collision. Moreover, the occupant restraint system of the present invention is suitable for restraining an occupant.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

What is claimed is:

1. A side collision detection system that detects a side collision of a vehicle, the side collision detection system comprising:
a first acceleration sensor which is attached to a beam of a door at a side of the vehicle and which detects an acceleration in a direction orthogonal to a travelling direction of the vehicle;
a second acceleration sensor which is provided at a side of the vehicle and which is different from the first acceleration sensor; and
a detection device which uses, as a safing signal for determining whether there is a collision, a first signal output by either one of the first and second acceleration sensors, uses, as a detection signal for determining a severity of the collision, a second signal output by another acceleration sensor, and detects a side collision happened to the vehicle.

2. The side collision detection system according to claim 1, wherein the first acceleration sensor is supported on the beam via a support member.

3. The side collision detection system according to claim 2, wherein the support member comprises:
a fixing part fixed to the beam; and
a support part which has elasticity and supports the first acceleration sensor at a location apart from the fixing part and which attenuates a force transmitted from the beam to the first acceleration sensor by the elasticity.

4. The side collision detection system according to claim 3, wherein the support part supports the first acceleration sensor at a location offset downwardly from the fixing part.

5. The side collision detection system according to claim 1, wherein the second acceleration sensor is attached to a pillar of the vehicle.

6. The side collision detection system according to claim 1, wherein
the vehicle has two doors at a side,
the first acceleration sensor is attached to the beam of either one of the two doors, and
the second acceleration sensor is attached to the beam of another door.

7. An occupant restraint system comprising:
the side collision detection system according to claim 1;
an occupant restraint device that restrains an occupant of the vehicle; and
a control device that controls the occupant restraint device when the side collision detection system detects a side collision.

8. The occupant restraint system according to claim 7, wherein
the occupant restraint device comprises:
an air bag for restraining an occupant of the vehicle; and
an expanding device that charges gas in an interior of the air bag to expand the air bag, and
the control device activates the expanding device in response to an output by the first or second acceleration sensor.
